(19) United States
(12) Patent Application Publication
(10) Pub. No.: US 2016/0345513 A1
(43) Pub. Date: Dec. 1, 2016

(54) PLANT CULTIVATION APPARATUS

(71) Applicant: CAL-COMP BIOTECH CO., LTD., New Taipei City (TW)

(72) Inventors: Wen-Hsin Lo, New Taipei City (TW); Wen-Jui Liu, New Taipei City (TW); Kuei-Mei Liu, New Taipei City (TW); Chia-Chin Tsai, New Taipei City (TW); Ming-Wei Chuang, New Taipei City (TW)

(21) Appl. No.: 14/819,411

(22) Filed: Aug. 5, 2015

(30) Foreign Application Priority Data
May 28, 2015 (TW) 104117147

(51) Int. Cl. A01G 9/24; A01G 7/04; A01G 9/02

(52) U.S. Cl. CPC A01G 9/24; A01G 9/02; A01G 7/045

(57) ABSTRACT

A plant cultivation apparatus includes a box, an illumination module, a thermoelectric cooling chip, a first heat dissipation module, and a second heat dissipation module. The box has a cover and a planting space. The cover has a first space and a second space separated from each other. The first space communicates with a surrounding environment. The second space communicates with the planting space. The illumination module assembled to the cover and located in the first space provides the planting space with light. The thermoelectric cooling chip assembled to the cover has a heating side located in the first space and a cooling side located in the second space. The first heat dissipation module located in the first space is thermally connected to the heating side and the illumination module. The second heat dissipation module located in the second space is thermally connected to the cooling side and the planting space.

### CROSS-REFERENCE TO RELATED APPLICATION

This application claims the priority benefit of Taiwan application serial no. 104117147, filed on May 28, 2015. The entirety of the above-mentioned patent application is hereby incorporated by reference herein and made a part of this specification.

### FIELD

The disclosure relates to a plant cultivation apparatus.

### DESCRIPTION OF RELATED ART

The conventional method of cultivating plants is directed to land farming in most cases. As time goes by, human beings have gradually recognized the way to apply appropriate and sufficient fertilizers to plants, so as to effectively grow the plants, reduce the time of growth, and increase the crop production. However, the conventional land farming technique requires a large area of land, whereby the overall production is restricted. Moreover, natural disasters including typhoons, rainstorms, drought, frostbite, and other climatic disasters pose a direct impact on the crop production and may even cause unpredictable loss.

At present, the crops with high economic values are cultivated mostly through protected cultivation, i.e., illumination, water, air, and other factors required by the growth of crops are monitored and controlled by facilities, so as to enhance the quality of crops with stable production and increase the market value of the crops. Nevertheless, the existing plant cultivation facilities are often employed to monitor the illumination manner and the irrigation manner, and the technique of controlling the temperature at which the plants are grown has not been mature enough.

For instance, if light-emitting diodes (LEDs) serve as the illumination source, the accompanying heat dissipation issue poses an impact on the temperature of the cultivation environment. Hence, how to employ the convenient LEDs (as the illumination source) that can be easily controlled and also monitor the growth temperature of the plants to ensure the environmental temperature is suitable for growing the plants has become one of the issues to be resolved in a prompt manner.

### SUMMARY

The disclosure is directed to a plant cultivation apparatus equipped with a thermoelectric cooling chip that controls both the temperature of an illumination module and the temperature at which plants are being cultivated.

In an embodiment of the disclosure, a plant cultivation apparatus that includes a box, an illumination module, a thermoelectric cooling chip, a first heat dissipation module, and a second heat dissipation module is provided. The box has a cover and a planting space. The cover has a first space and a second space separated from each other. The first space communicates with a surrounding environment, and the second space communicates with the planting space. The illumination module is assembled to the cover and located in the first space, and the illumination module provides the planting space with light. The thermoelectric cooling chip is assembled into the cover. The thermoelectric cooling chip has a heating side located in the first space and a cooling side located in the second space. The first heat dissipation module is located in the first space and thermally connected to the heating side. Here, the first heat dissipation module generates an air flow that flows to the surroundings through the illumination module, so as to dissipate heat generated by the illumination module. The second heat dissipation module is located in the second space and thermally connected to the cooling side, and the second heat dissipation module generates an air flow that flows to the planting space, so as to cool the planting space.

In view of the above, the separated first space and the second space of the cover are arranged, and the thermoelectric cooling chip is arranged at the intersection of the first space and the second space, such that the first heat dissipation module and the second heat dissipation module are thermally connected to the cooling side and the heating side of the thermoelectric cooling chip. By adjusting the difference in the temperature of the thermoelectric cooling chip, the temperature at the cooling side and the temperature at the heating side can be respectively lower than the temperature in the planting space and the temperature of the illumination module, such that the heat generated in the planting space and by the illumination module can be effectively dissipated by means of the thermoelectric cooling chip.

Several exemplary embodiments accompanied with figures are describe in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is an exploded view illustrating a plant cultivation apparatus according to an embodiment of the disclosure.

FIG. 2 is a schematic exploded view illustrating some components in the plant cultivation apparatus depicted in FIG. 1 at another view angle.

FIG. 3 and FIG. 4 are exploded views of the cover 114 at different view angles.

FIG. 5 is a cross-sectional view illustrating a portion of the plant cultivation apparatus depicted in FIG. 1 along a line I-I′.

### DETAILED DESCRIPTION OF DISCLOSED EMBODIMENTS

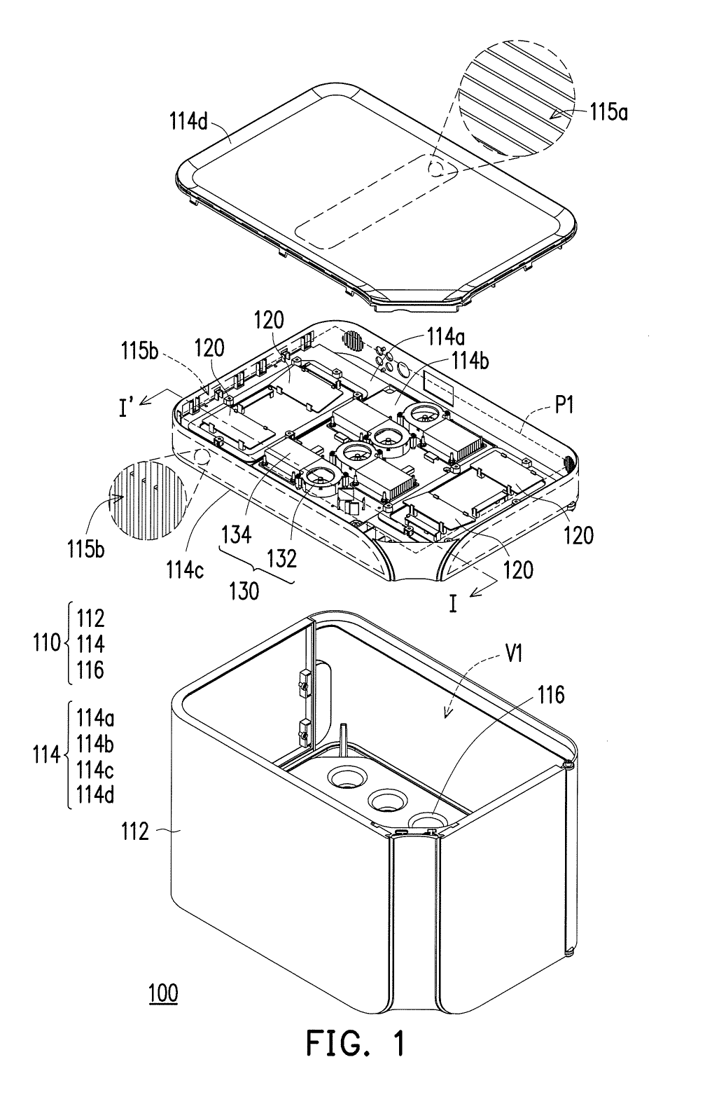

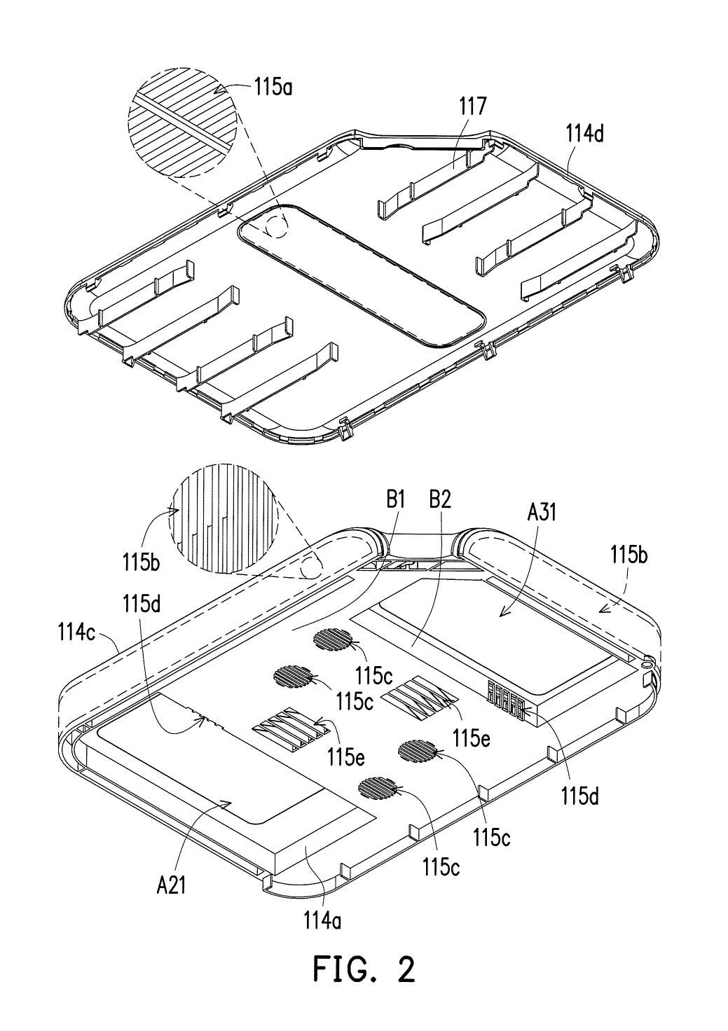

FIG. 1 is an exploded view illustrating a plant cultivation apparatus according to an embodiment of the disclosure. FIG. 2 is a schematic exploded view illustrating some components in the plant cultivation apparatus depicted in FIG. 1 at another view angle. With reference to FIG. 1 and FIG. 2, in the present embodiment, the plant cultivation apparatus 100 includes a box 110, an illumination module 120, a first heat dissipation module 130, and a second heat dissipation module 140. To be specific, the box 110 includes a body 112, a cover 114, and a cultivation tank 116. The cover 114 and the body 112 are combined to form planting space V1, and the cultivation tank 116 is located in the planting space V1 (at the bottom of the body 112). Soils or plants can be placed in the cultivation tank 116. Note that the disclosure does not pose any limitation to the way to grow plants.

In the present embodiment, the components of controlling environmental factors (i.e., temperature, air, water, and so forth), circuit driving components, and circuit control components are all arranged in the cover 114, such that these components are all driven by a control module (not shown), and that the growth environment of the plants in the planting space V1 can be monitored. That is, the components of controlling the environmental factors are all electrically connected to the control module, such that users are able to control the components through buttons or switches not covered by the cover 114.

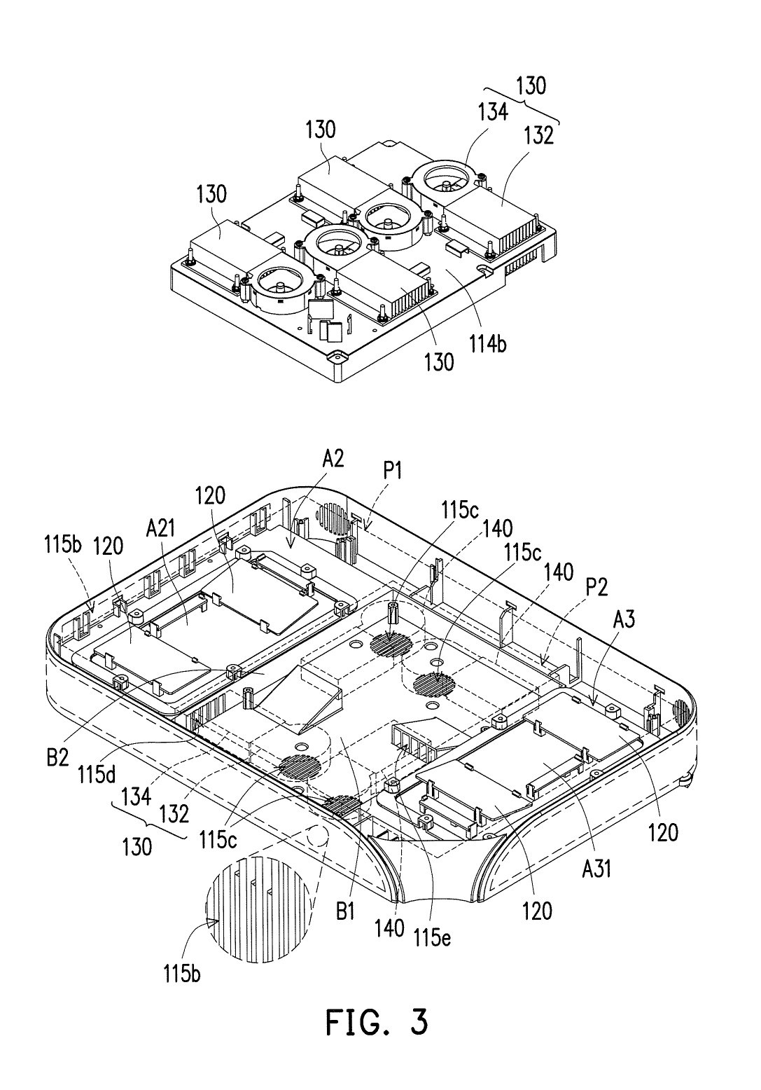

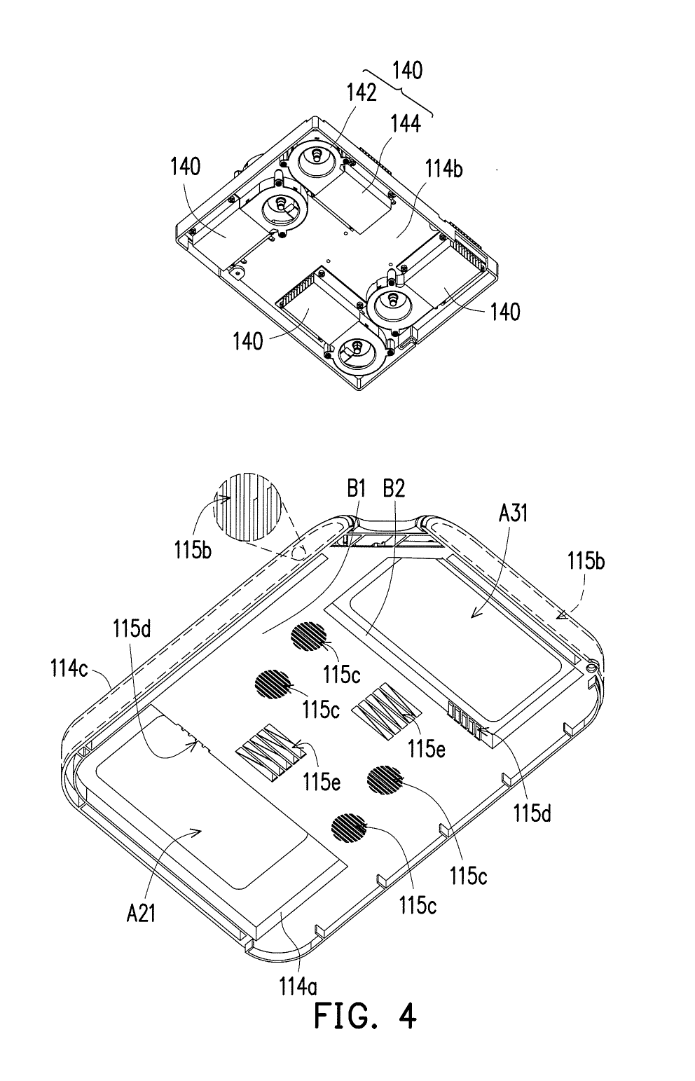

FIG. 3 and FIG. 4 are exploded views of the cover 114 at different view angles. With reference to FIG. 2 to FIG. 4, in the present embodiment, the cover 115 includes a main board 114a, a partition board 114b, a side board 114c, and a top board 114d. The main board 114a is suitable for being combined with the body 112 to form the planting space V1 and to act as the main structure of the cover 114, so as to hold the aforesaid control components. The side board 114c surrounds the main board 114a and is connected between the top board 114d and the main board 114a to form the space that can accommodate the control components.

As shown in FIG. 3, the main board 114a is shaped as a basin whose sides are higher than the bottom. Particularly, the main board 114a has a recess A1 located at the center of the main board 114a and platforms A2 and A3 located at two respective sides of the main board 114a. The recess A1 extends toward the planting space V1 below the cover 114, the illumination modules 120 are respectively arranged on the platforms A2 and A3, the platform A2 has a transparent portion A21, and the platform A3 has a transparent portion A31. Thereby, beams generated by the illumination modules 120 pass through the transparent portions A21 and A31 and are then transmitted to the planting space V1.

The first heat dissipation module 130 and the second heat dissipation module 140 are respectively located on two respective sides of the partition board 114b; one of the first heat dissipation module 130 and the second heat dissipation module 140 is placed on top, and the other is placed at the bottom. The partition board 114b is assembled to the recess A1 of the main board 114a, so as to further divide the space defined by the top board 114d, the side board 114c, and the main board 114a into first space P1 and second space P2 that are separated from each other, as shown in FIG. 1 and FIG. 3. Hence, the first heat dissipation module 130 and the illumination module 120 are located in the first space P1, and the second heat dissipation module 140 is located in the second space P2. Besides, the first space P1 communicates with the surrounding environments through slit openings 115b of the side board 114c and slit openings 115a of the top board 114d, and the second space P2 communicates with the planting space V1 through slit openings 115c, 115d, and 115e. As such, the first space P1 is independent from the second space P2, and one does not interfere with the other.

Note that the slit openings are depicted by dotted lines in order to clearly illustrate the components, and enlarged views of the slit openings are also provided.

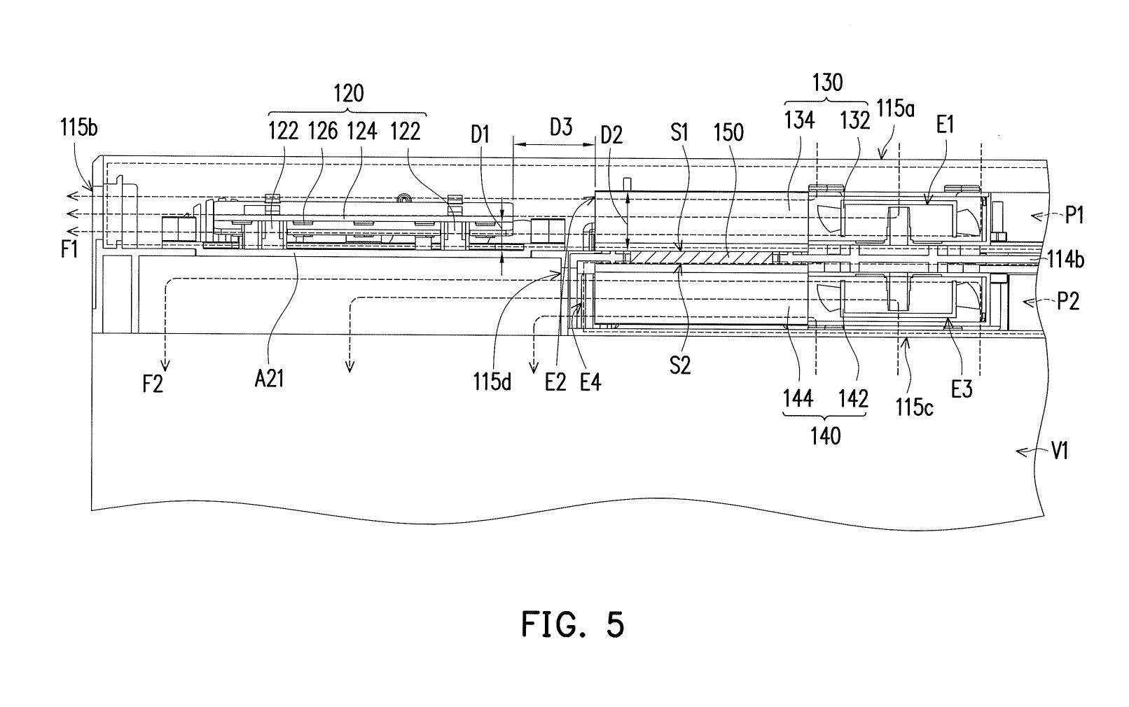

FIG. 5 is a cross-sectional view illustrating a portion of the plant cultivation apparatus depicted in FIG. 1 along a line I-I′. With reference to FIG. 3 to FIG. 5, in the present embodiment, the illumination module 120 includes a support member 122, a substrate 124, and a plurality of light-emitting units 126. The support member 122 is arranged on the transparent portion A21 or A31 of the main board 114a, the substrate 124 is arranged on the support member 122 and electrically connected to the control module, and the light-emitting units 126 are light-emitting diodes (LED) which are packaged on the substrate 124 and face the transparent portion A21 or A31. Here, the substrate 124 includes a packaged circuit board of the LEDs and heat dissipation fins configured to dissipate heat of the circuit board.

The light-emitting units 126 provides the planting space V1 with light through the transparent portion A21 or A31, and the light serves as the illumination source required by the growth of plants. However, the light also raises the temperature of the planting space V1. Both the light and the heat generated by the light-emitting units 126 may be transmitted via structural components or air, which leads to the increase in the temperature of the planting space V1. Such environment is unfavorable for the growth of plants. According to the present embodiment, the illumination module 120 generates a first temperature, and the planting space V1 generates a second temperature after the planting space V1 is irradiated by the light.

Here, the plant cultivation apparatus 100 provided herein further includes a thermoelectric cooling chip 150 that is lodged in the partition board 114b and substantially located at the intersection between the first space P1 and the second space P2. The first heat dissipation module 130 is thermally connected to a heating side of the thermoelectric cooling chip 150 in the first space P1, and the second heat dissipation module 140 is thermally connected to a cooling side of the thermoelectric cooling chip 150 in the second space P2. The thermoelectric cooling chip 150, the first heat dissipation module 130, and the second heat dissipation module 140 are electrically connected to and thus driven by the control module.

As shown in FIG. 1 to FIG. 4, the plant cultivation apparatus 100 includes four first heat dissipation modules 130 and four second heat dissipation modules 140. Since the structure and components of each of the first heat dissipation modules 130 are the same, and the structure and components of each of the second heat dissipation modules 140 are the same, the first heat dissipation module 130 and the second heat dissipation modules 140 shown in FIG. 5 are taken for explanatory purposes.

In the present embodiment, the first heat dissipation module 130 includes a fan 132 and a heat dissipation fin set 134. The fan 132 has an inlet E1, and the inlet E1 faces the slit openings 115b of the top board 114d. The heat dissipation fin set 134 is thermally connected to the heating side S1 of the thermoelectric cooling chip 150 and has an outlet E2, and the illumination module 120 is located between the slit openings 115a of the side board 114c and the outlet E2. Besides, the top board 114d has a plurality of air deflectors 117 respectively corresponding to the first heat dissipation modules 130 on the partition board 114b after the top board 114d, the main board 114a, and the side board 114c are assembled together.

Here, the inlets E1 of the fans 132 of the four first heat dissipation modules 130 all face the slit openings 115b of the top board 114d, which should however not be construed as a limitation to the disclosure.

Similarly, the second heat dissipation module 140 includes a fan 142 and a heat dissipation fin set 144. The fan 142 has an inlet E3, and the inlet E3 faces the slit openings 115c of the main board 114a. The heat dissipation fin set 144 is thermally connected to the cooling side S2 of the thermoelectric cooling chip 150 and has an outlet E2 facing the slit openings 115d and 115e of the main board 114a, such that the second heat dissipation module 140 is able to communicate with the planting space V1.

In response to different locations of the second heat dissipation modules 140, the slit openings 115c, 115d, and 115e are formed at a bottom portion B1 and a side portion B2 of the recess A1 of the main board 114a, which should however not be construed as a limitation to the disclosure.

In view of said arrangement, once the thermoelectric cooling chip 150 is activated, the cooling side S2 of the thermoelectric cooling chip 150 generates a third temperature, and the heating side Si generates a fourth temperature. Thereby, in the second space P2, the fan 142 of each second heat dissipation module 140 is able to absorb the air in the planting space V1 into the inlet E3 through the slit openings 115c at the bottom portion B1 of the main board 114a. The air is then blown to the heat dissipation fin set 144 by the fan 142 and undergoes heat exchange with the cooling side S2. After heat exchange, the air is again blown into the planting space V1 from the outlet E4 through the slit openings 115d at the side portion B2 of the main board 114a (and through the slit openings 115e at the bottom portion B1). As such, the cycle of heat exchange between the second space P2 and the planting space V1 is completed, as shown by the air flow F2.

On the other hand, in the first space P1, the fan 132 of each first heat dissipation module 130 is able to absorb the air in the surroundings into the inlet E1 through the slit openings 115a. The air is then blown to the heat dissipation fin set 134 by the fan 132 and undergoes heat exchange with the heating side S1. After heat exchange, the air is again blown into the surroundings from the cover 114 through the slit openings 115b of the side board 114c. As such, the cycle of heat exchange between the first space P2 and the surroundings is completed, as shown by the air flow F1.

Thereby, designers are able to control the difference in the temperature of the thermoelectric cooling chip 150 based on the temperature required for the growth of plants, such that the third temperature at the cooling side S2 is lower than the second temperature in the planting space V1, and that the fourth temperature at the heating side S1 is lower than the first temperature of the illumination module 120. As a result, the heat from the illumination module 120 and the planting space V1 can be dissipated.

For instance, the fourth temperature T4 at the heating side Si of the thermoelectric cooling chip 150 is controlled to fall within a range from 35° C. to 40° C. according to the material, the input current (voltage), and so forth. Hence, after the air flow flows through the heat dissipation fin set 134 of the first heat dissipation module 130, the temperature of the air flow is still lower than the first temperature of the LEDs 126 of the illumination module 120, and thus the air flow can still dissipate heat from the illumination module 120. After heat dissipation, the temperature of the illumination module 120 may stay at most 50° C. At this time, given that the temperature difference AT of the thermoelectric cooling chip 150 is 67° C., for instance, the third temperature at the cooling side S2 of the thermoelectric cooling chip 150 is about −32° C. Here, the third temperature is lower than the second temperature of the planting space V1 after the planting space V1 is being irradiated by the light from the illumination module 120. Thereby, the temperature of the planting space V1 can be controlled to fall within a range suitable for the growth of plants (e.g., 15° C.-25° C.).

In another embodiment that is not shown, the properties of the cooling side and the heating side of the thermoelectric cooling chip 150 can be exchanged if the thermoelectric cooling chip 150 is driven in a reverse manner (i.e., by applying a backward current flow or a negative voltage), and thereby the heating side is located in the second space P2 communicating with the planting space V1. At this time, the heating side allows the temperature of the planting space V1 to be raised. If the plant cultivation apparatus is located in a cold region, the temperature in the planting space V1 can still remain suitable for the growth of plants.

Besides, with reference to FIG. 5, in the first space P1, the partition board 114b and the transparent portions A21 and A31 are substantially coplanar. The substrate 124 of the illumination module 120 and the transparent portions A21 and A31 are spaced from each other by a first distance (D1), the heat dissipation fin set 134 of the first heat dissipation module 130 and the partition board 114b are spaced from each other by a second distance (D2), and (D1)≦⅔(D2). Thereby, the main heat generating source of the illumination module 120, i.e., the light-emitting units 126 and the substrate 124, can be arranged on the path of the air flow F1 flowing out of the heat dissipation fin set 134, and the heat generated by the illumination module 120 can be well dissipated. In another embodiment not shown in the drawings, (D1)≦½(D2), which can be determined according to the structural relationship between the first heat dissipation module 130 and the illumination module 120. That is, in the illumination module 120 provided in the present embodiment, the light-emitting units 126 and the substrate 124 corresponding to the transparent portions A21 and A31 of the main board 114 are suspended in the air, such that the air flow F1 flowing from the heat dissipation fin set 134 can exchange heat with the heat generating source. In another aspect, the substrate 124 of the illumination module 120 and the heat dissipation fin set 134 of the first heat dissipation module 130 are spaced from each other by a third distance (D3); if a rotation speed of the fan 132 is 3000 rpm-3500 rpm, the third distance (D3) is shorter than or equal to 5 cm. That is, the third distance (D3) is determined according to the rotation speed of the fan 132. Thereby, the air flow F1 flowing from the heat dissipation fin set 134 can encapsulate the light-emitting units 126 of the illumination module 120 and the substrate 124, so as to enhance the heat dissipation efficiency of the illumination module 120

To sum up, the thermoelectric cooling chip allows two heat dissipation modules to be thermally connected to the cooling side and the heating side of the thermoelectric cooling chip, respectively, so as to dissipate heat from the planting space and the illumination module in the plant cultivation apparatus. Thereby, even though the plants in the planting space is irradiated by the illumination module, the temperature in the planting space will be monitored by applying the heat dissipation modules and the thermoelectric cooling chip and will not be excessively high, and the heat dissipation issue of the illumination module can also be resolved. Namely, in the plant cultivation apparatus, the cooling side and the heating side of the thermoelectric cooling chip are located in two separated spaces, so as to dissipate heat generated by different sources; as a result, the utilization rate of the thermoelectric cooling chip can be effectively increased. Moreover, given that the plant cultivation apparatus is placed in a cold region, the thermoelectric cooling chip can be driven in a reverse manner, such that the heating side of the thermoelectric cooling chip can heat up the planting space, and that the temperature of the planting space can stay suitable for the growth of plants. Through said arrangement, the plant cultivation apparatus can be applied in diverse environments.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

What is claimed is:

1. A plant cultivation apparatus comprising:
a box having a cover and a planting space, the cover having a first space and a second space separated from each other, the first space communicating with a surrounding environment, the second space communicating with the planting space;
an illumination module assembled to the cover and located in the first space, the illumination module providing the planting space with light;
a thermoelectric cooling chip assembled to the cover, the thermoelectric cooling chip having a heating side located in the first space and a cooling side located in the second space;
a first heat dissipation module located in the first space and thermally connected to the heating side, wherein the first heat dissipation module generates an air flow flowing out of the cover through the illumination module, so as to dissipate heat generated by the illumination module; and
a second heat dissipation module located in the second space and thermally connected to the cooling side, wherein the second heat dissipation module generates an air flow flowing to the planting space, so as to dissipate heat from the planting space.

2. The plant cultivation apparatus of claim 1, wherein the illumination module generates a first temperature, the planting space generates a second temperature after the planting space is irradiated by the light, the cooling side of the thermoelectric cooling chip generates a third temperature, the heating side generates a fourth temperature, the fourth temperature is lower than the first temperature, and the third temperature is lower than the second temperature.

3. The plant cultivation apparatus of claim 2, wherein the fourth temperature is within a range from 35° C. to 40° C.

4. The plant cultivation apparatus of claim 1, wherein the first heat dissipation module and the second heat dissipation module respectively comprise a fan having an inlet and a heat dissipation fin set having an outlet, the heat dissipation fin sets are thermally connected to the cooling side and the heating side, respectively, in the first heat dissipation module, the inlet is connected to a surrounding environment, and the illumination module is adjacent to the outlet, and in the second heat dissipation module, the inlet and the outlet are connected to the planting space.

5. The plant cultivation apparatus of claim 1, wherein the box comprises a body, the cover comprises a main board, a side board, and a top board, the main board and the body are combined to form the planting space, and the side board surrounds the main board and is connected between the top board and the main board.

6. The plant cultivation apparatus of claim 5, wherein the cover further comprises a partition board, the main board has a recess, the partition board is assembled to the recess and divides the cover into the first space and the second space, and the first heat dissipation module and the second heat dissipation module are respectively located on two opposite surfaces of the partition board.

7. The plant cultivation apparatus of claim 6, wherein the illumination module is arranged on an area of the main board where no recess is formed, such that the illumination module provides the planting space with the light through a transparent portion of the main board.

8. The plant cultivation apparatus of claim 7, wherein the illumination module comprises:
at least one support member arranged on the main board;
a substrate arranged on the at least one support member; and
at least one light-emitting unit arranged on the substrate, the at least one light-emitting unit facing the transparent portion of the main board, wherein the substrate and the transparent portion are spaced from each other by a first distance (D1).

9. The plant cultivation apparatus of claim 8, wherein the partition board and the transparent portion are coplanar, the heat dissipation fin set of the first heat dissipation module and the partition board are spaced from each other by a second distance (D2), and (D1)≦⅔(D2).

10. The plant cultivation apparatus of claim 8, wherein the partition board and the transparent portion are coplanar, the heat dissipation fin set of the first heat dissipation module and the partition board are spaced from each other by a second distance (D2), and (D1)≦½(D2).

11. The plant cultivation apparatus of claim 8, wherein the substrate and the heat dissipation fin set of the first heat dissipation module are spaced from each other by a third distance (D3).

12. The plant cultivation apparatus of claim 11, wherein if a rotation speed of the fan is 3000 rpm-3500 rpm, the third distance (D3) is shorter than or equal to 5 cm.

13. The plant cultivation apparatus of claim 8, wherein the at least one light-emitting unit is a light-emitting diode or a plurality of light-emitting diodes.

14. The plant cultivation apparatus of claim 1, wherein the thermoelectric cooling chip is suitable for being driven to reverse the cooling side and the heating side, such that the heating side is located in the second space.
